(19) United States
(12) Patent Application Publication
(10) Pub. No.: US 2023/0146853 A1
(43) Pub. Date: May 11, 2023

(54) CYLINDRICAL SECONDARY BATTERY

(71) Applicant: Samsung SDI Co., Ltd., Yongin-si (KR)

(72) Inventors: Won Sug LEE, Yongin-si (KR); Ho Jae LEE, Yongin-si (KR); Jung Hyun PARK, Yongin-si (KR); Joo Youn SHIN, Yongin-si (KR); Myung Seob KIM, Yongin-si (KR); Ye Eun SHIN, Yongin-si (KR)

(21) Appl. No.: 18/054,478

(22) Filed: Nov. 10, 2022

(30) Foreign Application Priority Data
Nov. 11, 2021 (KR) 10-2021-0154827

(51) Int. Cl. H01M 50/531; H01M 10/0587; H01M 50/107; H01M 50/188; H01M 50/179

(52) U.S. Cl. CPC H01M 50/531; H01M 10/0587; H01M 50/107; H01M 50/188; H01M 50/179

(57) ABSTRACT

A cylindrical secondary battery including a can including a circular bottom part and a cylindrical side part having an opened one end, an electrode assembly in which a first electrode plate, a second electrode plate, and a separator are wound and which is accommodated in the can, and a collecting plate arranged in a direction toward the first electrode plate. The first electrode plate and the collecting plate, and the second electrode plate and the bottom part are electrically connected to each other in a non-welding manner. According to the embodiment, since the electrode assembly and the collecting plate and also the electrode assembly and the can are electrically connected to each other without the welding, the electrode assembly may be prevented or reduced from being damaged by foreign substances generated during the welding, thereby improving stability of the secondary battery.

### CROSS-REFERENCE TO RELATED APPLICATION

This application claims priority to and the benefit of Korean Patent Application No. 10-2021-0154827, filed on Nov. 11, 2021 in the Korean Intellectual Property Office, the content of which in its entirety is herein incorporated by reference.

### BACKGROUND

### 1. Field

Embodiments of the present disclosure described herein relate to a cylindrical secondary battery having a non-welding (e.g., non-welded) current collecting structure.

### 2. Description of the Related Art

A secondary battery includes a cell provided with an electrode assembly, which includes a positive electrode, a negative electrode, and a separator interposed between the positive electrode and the negative electrode, and an electrolyte impregnated in the electrode assembly.

The secondary battery may be provided in a variety of outer appearances such as cylindrical, prismatic, pouch type or kind, and/or the like depending on the use. Among them, the cylindrical secondary battery has a structure in which an electrode assembly and an electrolyte are accommodated inside a cylindrical can, and one end of the can is sealed with a cap assembly. Generally, in a cylindrical secondary battery, a collecting plate is laser-welded to a base material (non-coating portion) of an electrode assembly. Thereafter, a negative collecting plate is resistance-welded or laser-welded to a bottom surface of a can, and a positive collecting plate is connected to a lead tab through laser welding and then is laser-welded to a cap assembly.

In a method for manufacturing a cylindrical secondary battery, due to characteristics of the laser welding, there may be a limitation in completely preventing and/or reducing an occurrence of spatter or dross, and a separator may be damaged due to the spatter and/or the like, or metallic foreign substances exist may not be detected when inspected. Therefore, there is a need for a method for solving the limitation due to the welding and securing safety of the secondary battery.

The above-described information disclosed in the technology that serves as the background of the present disclosure is only for improving understanding of the background of the present disclosure and thus may include information that does not constitute the related art.

### SUMMARY

An aspect of the present disclosure is directed toward a cylindrical secondary battery a non-welding current collecting structure.

According to one or more embodiments, a cylindrical secondary battery includes: a can including a circular bottom part and a cylindrical side part having an opened one end; an electrode assembly in which a first electrode plate, a second electrode plate, and a separator are wound and which is accommodated in the can; and a collecting plate arranged (e.g., disposed) in a direction toward the first electrode plate, wherein the first electrode plate and the collecting plate, and the second electrode plate and the bottom part are electrically connected to each other in a non-welding manner.

The first electrode plate may be a positive electrode plate including a first electrode non-coating portion, and an end of the side part may be curled to press the collecting plate so that the first electrode non-coating portion and the collecting plate are in close contact with each other.

The cylindrical secondary battery may further include a gasket inserted between the collecting plate and the side part to insulate the can from the insulating plate.

The second electrode plate may be a negative electrode plate including a second electrode non-coating portion, and when the end of the side part may be curled to press the collecting plate, the second electrode non-coating portion is pressed to be in close contact with the bottom part.

The cylindrical secondary battery may further include a core pin inserted into a winding center of the electrode assembly.

The core pin may protrude outward more than the separator, and each of the first electrode non-coating portion and the second electrode non-coating portion may protrude outward more than the core pin.

A length by which the first electrode non-coating portion is compacted may correspond to a length from an end of the first electrode non-coating portion to an end of the core pin, and a length by the second electrode non-coating portion is compacted may correspond to a length from an end of the second electrode non-coating portion to the end of the core pin.

The core pin may protrude outward more than the separator, wherein the first electrode non-coating portion may protrude outward more than an end of the core pin, and the other end of the core pin may protrude outward more than the second electrode non-coating portion.

An insertion groove into which the other end of the core pin is inserted may be defined in the bottom part.

A length by which the first electrode non-coating portion is compacted may correspond to a length from an end of the first electrode non-coating portion to one end of the core pin, and a length by the second electrode non-coating portion is compacted may correspond to a depth of the insertion groove.

The depth of the insertion groove may be greater than a distance between the other end of the core pin and a lower end of the second electrode non-coating portion.

The core pin may be made of an insulating material.

A through-hole may be defined in the bottom part, and the core pin may be made of a conductive material.

The cylindrical secondary battery may further include: a positive electrode terminal which is inserted into the through-hole and is electrically connected to the core pin; and a terminal gasket configured so that the positive electrode terminal and the bottom part are insulated from and sealed with respect to each other.

The core pin may have a plurality of through-holes in an outer circumferential surface thereof in a circumferential direction.

### BRIEF DESCRIPTION OF THE DRAWINGS

FIG. 1 is a cross-sectional view illustrating a cylindrical secondary battery according an embodiment;

FIG. 2 is an exploded perspective view illustrating a current collecting structure of the cylindrical secondary battery of FIG. 1 according to an embodiment;

FIG. 3A is a cross-sectional view illustrating a portion of a positive electrode of the current collecting structure of FIG. 1 according to an embodiment;

FIG. 3B is a cross-sectional view illustrating a portion of a negative electrode of the current collecting structure of FIG. 1 according to an embodiment;

FIG. 4A is a cross-sectional view illustrating a state in which an electrode assembly and a positive electrode collecting plate of FIG. 1 are coupled to each other according to an embodiment;

FIG. 4B is a cross-sectional view illustrating a state in which the electrode assembly and a can of FIG. 1 are connected to each other according to an embodiment;

FIG. 4C is a cross-sectional view illustrating a state in which the positive electrode collecting plate and the can of FIG. 1 are coupled to each other according to an embodiment;

FIG. 5 is a cross-sectional view illustrating a portion of a negative electrode of a cylindrical secondary battery according to an embodiment; and

FIGS. 6-11 are perspective views illustrating a method for manufacturing a cylindrical secondary battery according to an embodiment.

### DETAILED DESCRIPTION

The present disclosure may, however, be embodied in many different forms and should not be construed as being limited to the embodiments set forth herein; rather, these embodiments are provided so that those skilled in the art thoroughly understand the present disclosure. Rather, these embodiments are provided so that this disclosure will be more thorough and complete, and will fully convey the disclosure to those skilled in the art.

In some embodiments, in the following drawings, the thickness or size of each layer is exaggerated for convenience and clarity of description, and the same reference numerals in the drawings refer to the same elements. As utilized herein, the term “and/or” includes any and all combinations of one or more of the associated listed items. In this specification, it will also be understood that when a member A is referred to as being connected to a member B, the member A can be directly connected to the member B or indirectly connected to the member B with a member B therebetween.

The terms utilized herein are for illustrative purposes of the present disclosure only and should not be construed to limit the meaning or the scope of the present disclosure. As utilized in this specification, a singular form may, unless definitely indicating a particular case in terms of the context, include a plural form. Also, the expressions “comprise/include” and/or “comprising/including” utilized in this specification neither define the mentioned shapes, numbers, steps, operations, members, elements, and/or groups of these, nor exclude the presence or addition of one or more other different shapes, numbers, steps, operations, members, elements, and/or groups of these, or addition of these. The term “and/or” utilized herein includes any and all combinations of one or more of the associated listed items.

As utilized herein, terms such as “first,” “second,” etc. are utilized to describe one or more suitable members, components, areas, layers, and/or portions. However, it is obvious that the members, components, areas, layers, and/or portions should not be defined by these terms. The terms do not refer to a particular order, up and down, or superiority, and are utilized only for distinguishing one member, component, area, layer, or portion from another member, component, area, layer, or portion. Thus, a first member, component, area, layer, or portion which will be described may also refer to a second member, component, area, layer, or portion, without departing from the teaching of the present disclosure.

Spatially relative terms, such as “below”, “beneath”, “lower”, “above”, “upper” and/or the like, may be utilized herein for ease of description to describe one element or feature's relationship to another element(s) or feature(s) as illustrated in the drawings. These spatially relative terms are intended for easy comprehension of the present disclosure according to one or more suitable process states or usage states of the present disclosure, and thus, the present disclosure is not limited thereto. For example, an element or feature shown in the drawings is turned inside out, the element or feature described as “beneath” or “below” may change into “above” or “upper”. Thus, the term “lower” may encompass the term “upper” or “below”.

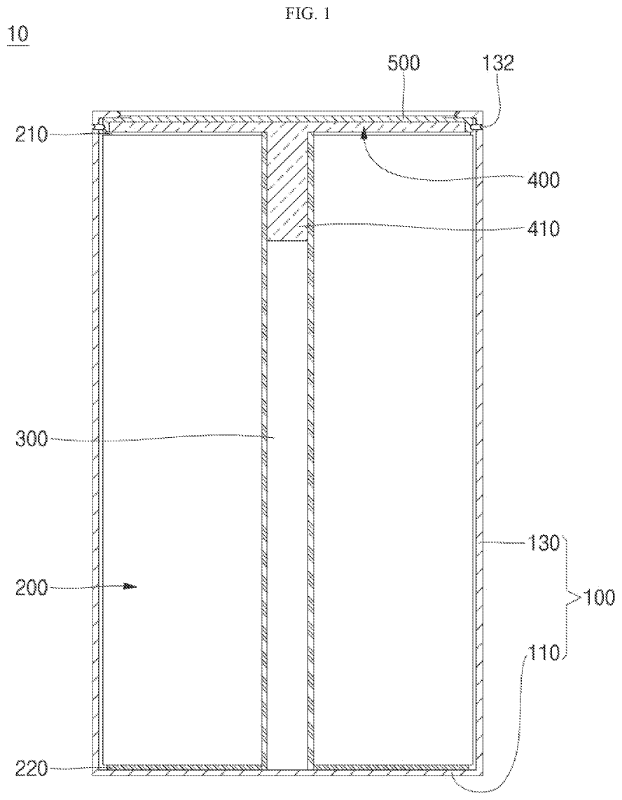

Hereinafter, a cylindrical secondary battery according to an embodiment will be described in more detail with reference to the accompanying drawings (for convenience, an upper side is defined as an upper portion, and a lower side is defined as a lower portion based on FIG. 1).

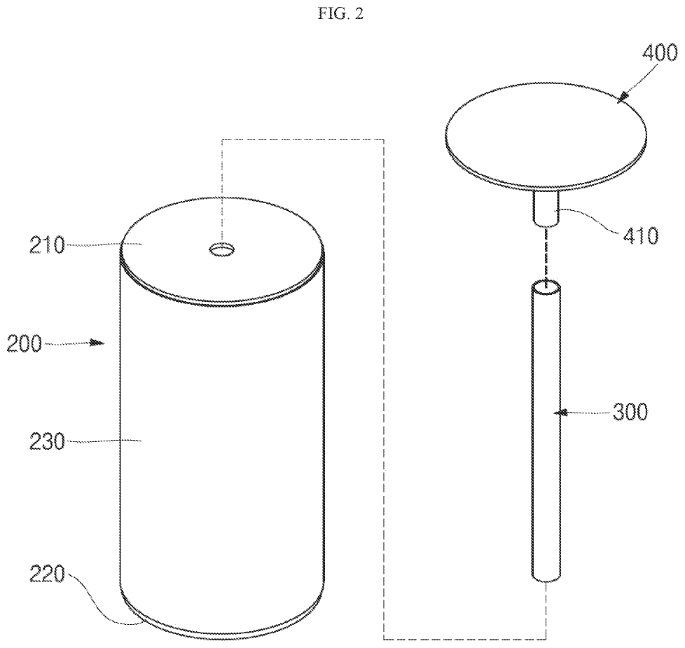

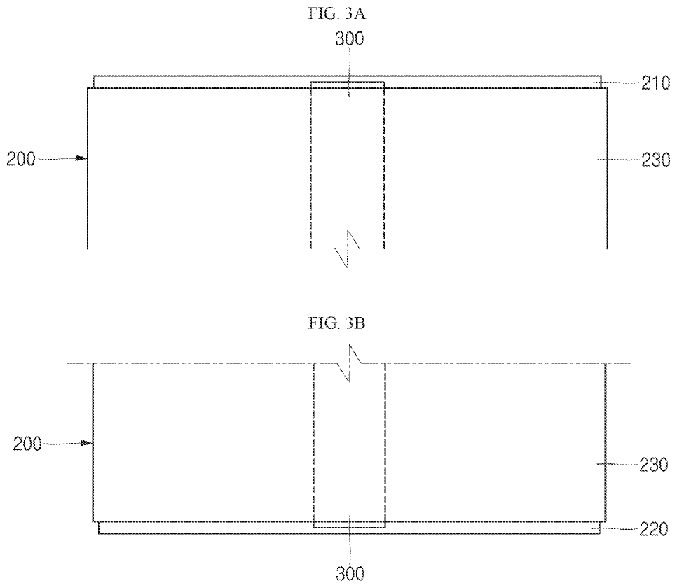

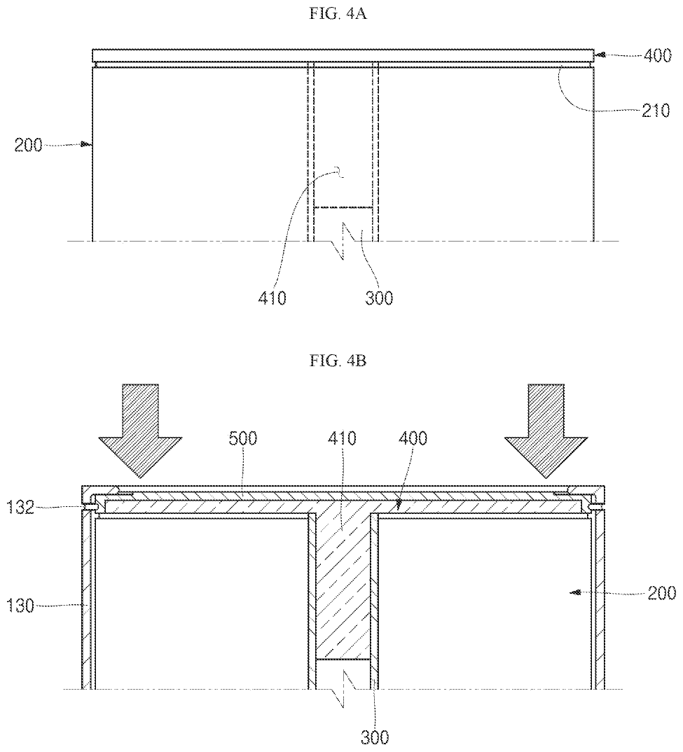

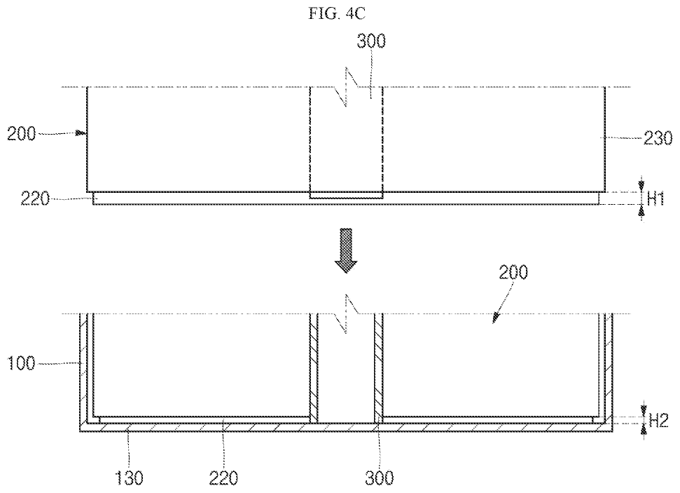

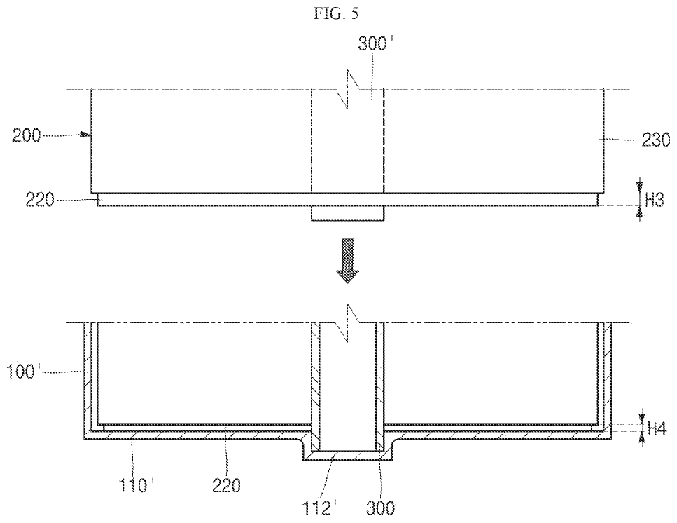

FIG. 1 is a cross-sectional view illustrating a cylindrical secondary battery according an embodiment. FIG. 2 is an exploded perspective view illustrating a current collecting structure of the cylindrical secondary battery of FIG. 1. FIG. 3A is a cross-sectional view illustrating a portion of a positive electrode of the current collecting structure of FIG. 1. FIG. 3B is a cross-sectional view illustrating a portion of a negative electrode of the current collecting structure of FIG. 1. FIG. 4A is a cross-sectional view illustrating a state in which an electrode assembly and a positive electrode collecting plate of FIG. 1 are coupled to each other. FIG. 4B is a cross-sectional view illustrating a state in which the electrode assembly and a can of FIG. 1 are connected to each other. FIG. 4C is a cross-sectional view illustrating a state in which the positive electrode collecting plate and the can of FIG. 1 are coupled to each other.

As illustrated in FIGS. 1 and 2, a cylindrical secondary battery 10 according to an embodiment may include a cylindrical can 100 and an electrode assembly 200 inserted into the can 100. A first electrode of the electrode assembly 200 may be electrically connected to a collecting plate 400 in a non-welding manner, and a second electrode may be electrically connected to the can 100 in a non-welding manner. The collecting plate 400 is insulated from the can 100 by a ring-shaped gasket 500.

The can 100 may include a circular bottom part 110 and a side part 130 extending upward from the bottom part 110. The second electrode of the electrode assembly 200 is electrically connected to the bottom part 110. The side part 130 has a cylindrical shape, and an upper end of the side part 130 is opened to define an opening. The bottom part 110 and the side part 130 may be integrated with each other or may be separately provided to be coupled to each other. In a process of manufacturing the secondary battery 10, the electrode assembly together with an electrolyte is accommodated in the can 100 through an opening, and the collecting plate 400 is connected to the electrode assembly 200. Thereafter, after forming a beading part 132 on the side part 130, the gasket 500 is inserted, and an end of the side part is curled to seal the can 100. The can 100 may be made of steel, a steel alloy, nickel-plated steel, a nickel-plated steel alloy, aluminum, an aluminum alloy, or an equivalent thereof, but is not limited thereto.

As illustrated in FIGS. 2 to 3B, the electrode assembly 200 may include a first electrode plate, a second electrode plate, and a separator 230. A cylindrical core pin 300 serving as a winding center of the electrode assembly 200 to support the electrode assembly 200 so that the electrode assembly is maintained in its shape may be inserted into a center of the electrode assembly 200. The core pin 300 may be made of an insulating material.

For example, the first electrode plate may be a positive electrode plate on which a positive electrode active material layer (e.g., transition metal oxide (LiCoO₂, LiNiO₂, LiMn₂O₄, etc.)) is disposed on each of both (e.g., simultaneously) surfaces of aluminum foil. A first electrode non-coating portion 210 on which the positive electrode active material layer is not disposed may be disposed on a portion of the first electrode plate. The first electrode non-coating portion 210 may be disposed to face the opening of the can 100. As illustrated in FIG. 3A, the core pin 300 may protrude outward more than the separator 230, and the first electrode non-coating portion 210 may protrude outward more than the core pin 300. For example, the first electrode non-coating portion 210 protrudes upward more than the core pin 300.

Also, for example, the second electrode plate may be a negative electrode plate on which a negative active material layer (e.g., graphite, carbon, etc.) is disposed on each of both (e.g., simultaneously) surfaces of copper (Cu) or nickel (Ni) foil. A second electrode non-coating portion to which the negative electrode active material layer is not disposed may be disposed on a portion of the second electrode plate.

The second electrode non-coating portion may be disposed to face the bottom part 110 of the can 100. As illustrated in FIG. 3B, the core pin 300 may protrude outward more than the separator 230, and the second electrode non-coating portion 220 may protrude outward more than the core pin 300. For example, the second electrode non-coating portion 220 protrudes downward more than the core pin 300.

The separator 230 may be interposed between the first electrode plate and the second electrode plate to prevent or reduce short circuit from occurring and allow lithium ions to move only. The separator 230 may be made of polyethylene (PE) or polypropylene (PP), but the embodiment is not limited thereto. As illustrated in FIG. 2, the separator 230 may have a length less than that of the core pin 300 in the winding state of the electrode assembly 200.

Hereinafter, the current collecting structure of the secondary battery 10 will be described in more detail.

As illustrated in FIG. 2, the collecting plate 400 may be a disk-shaped plate, and a cylindrical insertion part 410 inserted into the core pin 300 may be disposed on a bottom surface of the collecting plate 400. The insertion part 410 may be integrated with the collecting plate 400 or may be separately provided from and coupled to the collecting plate by welding and/or the like. Because the collecting plate 400 is electrically connected to the first electrode plate, the collecting plate 400 may be made of a conductive material. For example, the collecting plate 400 may be made of the same material as the first electrode plate. The collecting plate 400 may be insulated from the can 100 by the gasket 500 and may function as a cap assembly that closes the opening of the can 100. In one or more embodiments, a notch may be provided in the collecting plate 400 and thus be ruptured when a gas pressure equal to or greater than a set or predetermined pressure is generated, thereby performing a function of discharging a gas inside the secondary battery 10. When the insertion part 410 of the collecting plate 400 is inserted into an upper portion of the core pin 300, a bottom surface of the collecting plate 400 may be in contact with the first electrode non-coating portion 210.

As illustrated in FIG. 4B, when the side part 130 of the can 100 is curled to press the gasket 500, the gasket 500 may press the collecting plate 400 downward.

As the collecting plate 400 is pressed downward by external force, the first electrode non-coating portion 210 is pressed and compacted. However, because the core pin 300 protrudes outward more than the separator 230, the collecting plate 400 moves downward only until the collecting plate 400 is in contact with an upper end of the core pin 300. Thus, the first electrode non-coating portion 210 is not compacted by a distance between the upper end of the core pin 300 and the upper end of the separator 230. For example, the first electrode non-coating portion 210 is compacted by a distance obtained by subtracting the distance between the upper end of the core pin 300 and the upper end of the separator 230 from a distance between an upper end of the first electrode non-coating portion 210 and an end of the separator 230. As described above, the first electrode non-coating portion 210 and the collecting plate 400 may be electrically connected to each other without welding.

Also, as illustrated in FIG. 4C, the collecting plate 400 is pressed downward by pressing the gasket 500, and thus, because the electrode assembly 200 is pushed downward, the lower second electrode non-coating portion 220 may be also pressed. The second electrode non-coating portion 220 may be compacted while being pushed toward the bottom part 110 of the can 100 and may be electrically connected to the bottom part 110 without welding. Here, the second electrode non-coating portion 220 is compacted by a length obtained by subtracting a distance H2 between a lower end of the core pin 300 and a lower end of the separator 230 from a distance H1 between a lower end of the second electrode non-coating portion 220 and the lower end of the separator 230. For example, the length remaining after the second electrode non-coating portion 220 is compacted becomes the distance H2 of FIG. 4C.

A connection structure between the above-described second electrode plate and the can may be provided in a different form. Hereinafter, other embodiments of the present disclosure will be described (a more detailed description of the same components and features as those of the above-described embodiments will not be provided).

FIG. 5 is a cross-sectional view illustrating a portion of a negative electrode of a cylindrical secondary battery according to another embodiment.

As illustrated in FIG. 5, in an electrode assembly 200, a second electrode non-coating portion 220 may protrude downward more than a separator 230, and a core pin 300′ may protrude downward more than the second electrode non-coating portion 220′ (here, the first electrode non-coating portion protrudes outward more than an upper end of the core pin as in the embodiment of FIG. 3A). In some embodiments, an insertion groove 112′ into which a lower end of the core pin 300′ is inserted into a center of a bottom part 110′ of the can 100′ is defined in the can 100′.

Because the insertion groove 112′ has a depth greater than a thickness of the bottom part 110′, a portion at which the insertion groove 112′ is defined may protrude downward more than the bottom part 110′ when viewed from the outside of the can 100′. When the electrode assembly 200 is inserted into the can 100′ and curled so that the electrode assembly 200 is pressed, the core pin 300′ is inserted into the insertion groove 112′. The second electrode non-coating portion 220 is compacted while being pressed as much as the core pin 300′ is inserted into the insertion groove 112′ (the second electrode non-coating portion 220 is compacted by the depth of the insertion groove). As the second electrode non-coating portion 220 is compacted from a length of H3 to a length of H4, the bottom part 110′ of the can 100′ and the second electrode non-coating portion 220 are in close contact with each other and are electrically connected to each other without welding. For this, the depth of the insertion groove 112′ may be greater than the distance between the lower end of the core pin 300′ and the lower end of the second electrode non-coating portion 220.

A cylindrical secondary battery 10″ may have a structure in which both (e.g., simultaneously) a positive electrode terminal and a negative electrode terminal are disposed at a bottom portion.

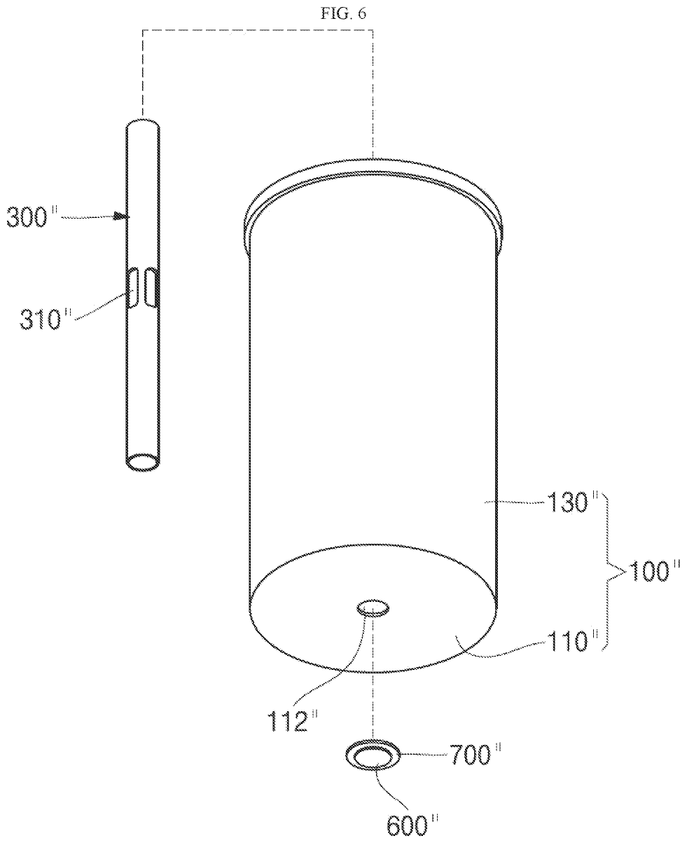

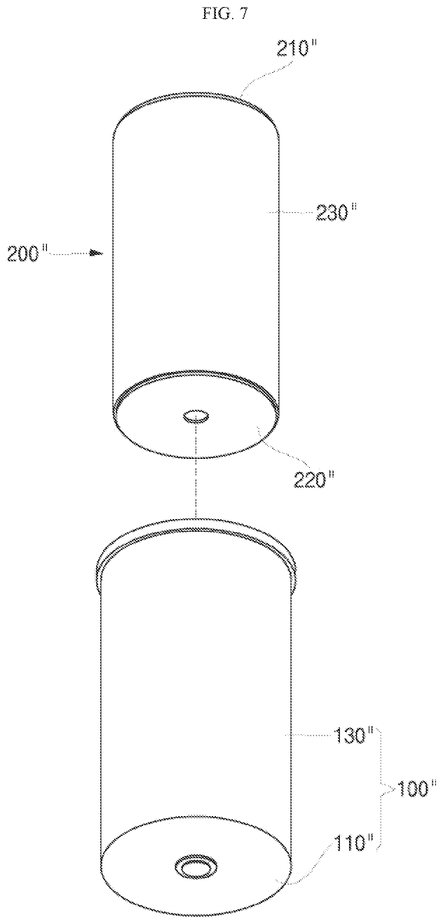

FIGS. 6 to 10 are perspective views illustrating a method for manufacturing a cylindrical secondary battery according to an embodiment (for convenience, an upper side is defined as an upper portion, and a lower side is defined as a lower portion in FIG. 6).

As illustrated in FIGS. 6 to 9, the cylindrical secondary battery 10″ may include a cylindrical can 100″ having a bottom part 110″ and a side part 130″, an electrode assembly 200″ inserted into the can 100″, a core pin 300″ inserted into a winding center of the electrode assembly 200″, a collecting plate 400″ electrically connected to a first electrode non-coating portion 210″ disposed at a side of a positive electrode of the electrode assembly 200″, a gasket 500″ insulating the collecting plate 400″ from the can 100″, a positive electrode terminal 600″, and a terminal gasket 700″.

As illustrated in FIGS. 6 to 8, a through-hole into which the positive electrode terminal 600″ is inserted may be formed in a center of the bottom part 110″ of the can 100″, and a stepped part 123″ on which the gasket 500″ is seated may be formed adjacent to an upper end of the side part 130″ of the can 100″. A portion at which the stepped part 123″ may have a diameter slightly greater than that of the side part 130″.

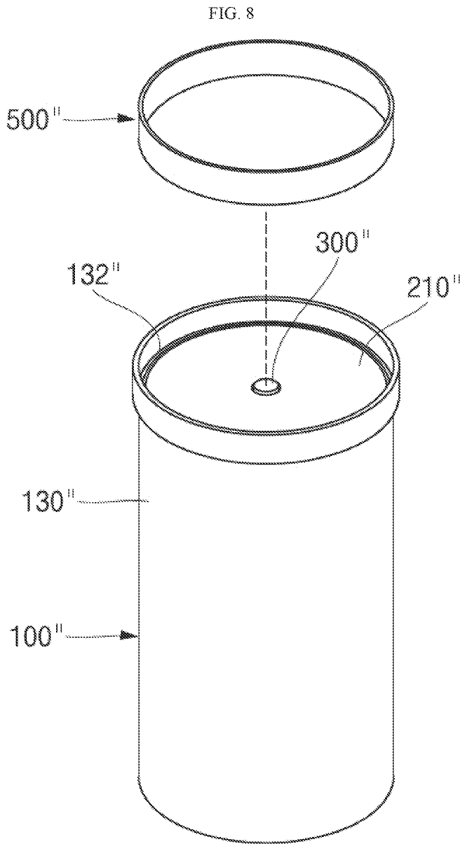

As illustrated in FIG. 7, in the electrode assembly 200″, as in the above-described embodiment, each of the first electrode non-coating portion 210″ and the second electrode non-coating portion 220″ has a structure that protrudes outward more than the separator 230″.

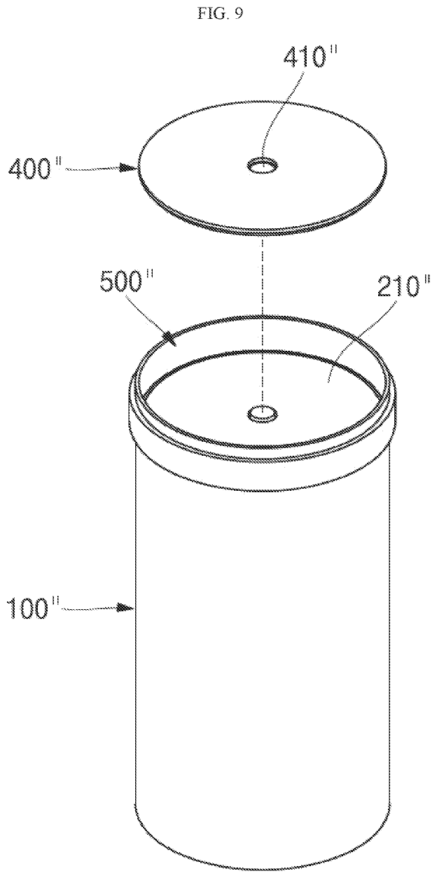

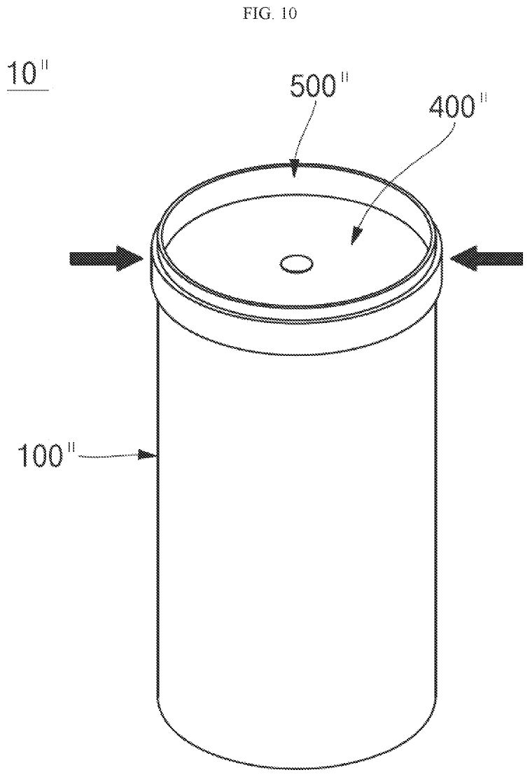

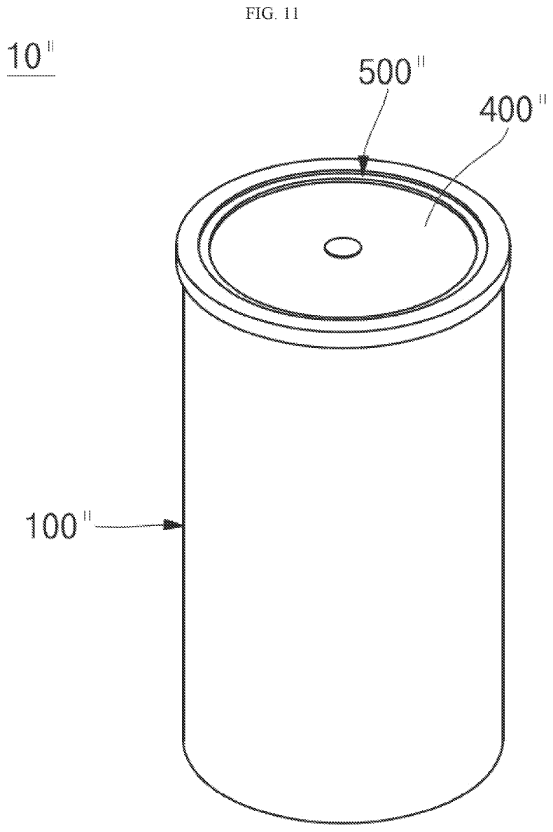

As illustrated in FIG. 6, the core pin 300″ has a cylindrical shape and may be made of a conductive material. For example, the core pin 300″ may be made of the same material as the collecting plate 400″. As an upper end of the core pin 300″ is electrically connected to the collecting plate 400″, the core pin 300″ is electrically connected to the first electrode non-coating portion 210″ of the electrode assembly 200″ (see FIGS. 9 and 10). In some embodiments, as a lower end of the core pin 300″ is electrically connected to the positive electrode terminal 600″, the collecting plate 400″ is electrically connected to the positive electrode terminal 600″. A plurality of through-holes 310″ may be formed with each other in the core pin 300 along a circumferential direction. Because an area of the portion in which the through-hole 310″ is formed is reduced, a corresponding portion when overvoltage occurs may be quickly broken to serve as a fuse.

As illustrated in FIGS. 9 and 10, the collecting plate 400″ has a hollow disk shape and is in contact with the first electrode non-coating portion 210″ of the positive electrode plate, and thus, the upper end of the core pin 300″ is inserted into the hollow. In one or more embodiments, a notch may be formed in the collecting plate 400″ for a vent function. The collecting plate 400″ is insulated from the side part 130 “of the can 100” by the gasket 500″. When the collecting plate 400″ is pressed by curling the side part 130″ of the can 100″ in the state in which the collecting plate 400″ is in contact with the first electrode non-coating portion 210″, the first electrode non-coating portion 210″ and the collecting plate 400″ are in close contact with each other, and also, the second electrode non-coating portion 220″ and the bottom part 110″ of the can 100″ are in close contact with each other. Here, the structure in which the first electrode non-coating portion 210″ and the second electrode non-coating portion 220″ are compacted and in close contact with the collecting plate 400″ and the bottom part 110″ so as to be electrically connected to each other is configured in substantially the same principle as the above-described embodiment. Thus, the collecting plate 400″ electrically connected to the first electrode non-coating portion 210″ serves as a positive electrode, and the bottom part 110″ electrically connected to the second electrode non-coating portion 220″ serves as a negative electrode.

As illustrated in FIG. 6, the positive electrode terminal 600″ is insulated from and sealed with the bottom part 110″ of the can 100″ by the ring-shaped gasket 500″ and is electrically connected to the core pin 300″ by being in contact with the core pin 300″. Because the bottom of the can 100″ is a negative electrode, both (e.g., simultaneously) the positive electrode and the negative electrode are disposed under the secondary battery 10″.

When briefly describing a process of manufacturing the cylindrical secondary battery 10″ according to this embodiment with reference to the drawings, as illustrated in FIG. 6, the positive electrode terminal 600″ and the terminal gasket 700″ are inserted into the bottom part 110″ of the can 100″, and the core pin 300″ may be inserted into the can 100″ and then connected to the positive electrode terminal 600″. The terminal gasket 700″ may firstly adhere to the bottom part 110″ after thermal processing before being coupled to the positive electrode terminal 600″. The positive electrode terminal 600″ and the core pin 300″ may be electrically connected through welding and/or the like or may be electrically connected through a non-welding method such as applying of press-fitting/rivet/screw/bolt structure.

Thereafter, as illustrated in FIG. 7, the electrode assembly 200″ may be inserted into the can 100″, and then, an electrolyte is injected, and as illustrated in FIGS. 8 and 9, the gasket 500″ may be seated on a stepped part 123″. As illustrated in FIG. 9, the collecting plate 400″ is inserted, and as illustrated in FIG. 10, an end of the side part 130″ is pressed and curled in a direction toward the core pin 300″. Accordingly, the gasket 500″ and the collecting plate 400″ are fixed while being pressed by the end of the side part 130″. In this process, the first electrode non-coating portion 210″ and the second electrode non-coating portion 220″ are electrically connected to the collecting plate 400″ and the bottom part 110″ without welding, respectively.

According to the foregoing embodiments, because the electrode assembly and the collecting plate and also the electrode assembly and the can are electrically connected to each other without welding, the electrode assembly may be prevented or reduced from being damaged by the foreign substances generated during welding, thereby improving the stability of the secondary battery. In some embodiments, because the welding process is omitted in the process of manufacturing the secondary battery, the number of manufacturing processes may be reduced, and also, the costs may be reduced.

According to the embodiment, because the electrode assembly and the collecting plate and also the electrode assembly and the can are electrically connected to each other without welding, the electrode assembly may be prevented or reduced from being damaged by the foreign substances generated during welding, thereby improving the stability of the secondary battery.

In some embodiments, because the welding process is omitted in the process of manufacturing the secondary battery, the number of manufacturing processes may be reduced, and also, the costs may be reduced.

The above-mentioned embodiment is merely an embodiment, and thus, the present disclosure is not limited to the foregoing embodiment, and also it will be understood by those of ordinary skill in the art that one or more suitable changes in form and details may be made therein without departing from the embodiment and scope of the present disclosure as defined by the following claims and equivalents thereof.

As used herein, the terms “use,” “using,” and “used” may be considered synonymous with the terms “utilize,” “utilizing,” and “utilized,” respectively.

The use of “may” when describing embodiments of the present disclosure refers to “one or more embodiments of the present disclosure.”

As used herein, the singular forms “a”, “an” and “the” are intended to include the plural forms as well, unless the context clearly indicates otherwise.

The vehicle, a battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

What is claimed is:

1. A cylindrical secondary battery comprising:
a can comprising a circular bottom part and a cylindrical side part having an opened one end;
an electrode assembly in which a first electrode plate, a second electrode plate, and a separator are wound and which is accommodated in the can; and
a collecting plate arranged in a direction toward the first electrode plate,
wherein the first electrode plate and the collecting plate, and the second electrode plate and the bottom part are electrically connected to each other in a non-welding manner.

2. The cylindrical secondary battery of claim 1, wherein the first electrode plate is a positive electrode plate comprising a first electrode non-coating portion, and
an end of the cylindrical side part is curled to press the collecting plate so that the first electrode non-coating portion and the collecting plate are in close contact with each other.

3. The cylindrical secondary battery of claim 2, further comprising a gasket inserted between the collecting plate and the side part to insulate the can from an insulating plate.

4. The cylindrical secondary battery of claim 3, wherein the second electrode plate is a negative electrode plate comprising a second electrode non-coating portion, and
when the end of the cylindrical side part is curled to press the collecting plate, the second electrode non-coating portion is pressed to be in close contact with the bottom part.

5. The cylindrical secondary battery of claim 4, further comprising a core pin inserted into a winding center of the electrode assembly.

6. The cylindrical secondary battery of claim 5, wherein the core pin protrudes outward more than the separator, and
each of the first electrode non-coating portion and the second electrode non-coating portion protrudes outward more than the core pin.

7. The cylindrical secondary battery of claim 6, wherein a length by which the first electrode non-coating portion is compacted corresponds to a length from an end of the first electrode non-coating portion to an end of the core pin, and
a length by the second electrode non-coating portion is compacted corresponds to a length from an end of the second electrode non-coating portion to the end of the core pin.

8. The cylindrical secondary battery of claim 5, wherein the core pin protrudes outward more than the separator, wherein the first electrode non-coating portion protrudes outward more than an end of the core pin, and the other end of the core pin protrudes outward more than the second electrode non-coating portion.

9. The cylindrical secondary battery of claim 8, wherein an insertion groove into which the other end of the core pin is inserted is defined in the bottom part.

10. The cylindrical secondary battery of claim 9, wherein a length by which the first electrode non-coating portion is compacted corresponds to a length from an end of the first electrode non-coating portion to one end of the core pin, and a length by the second electrode non-coating portion is compacted corresponds to a depth of the insertion groove.

11. The cylindrical secondary battery of claim 10, wherein the depth of the insertion groove is greater in distance than that between the other end of the core pin and a lower end of the second electrode non-coating portion.

12. The cylindrical secondary battery of claim 11, wherein the core pin is composed of an insulating material.

13. The cylindrical secondary battery of claim 7, wherein a through-hole is defined in the bottom part, and
the core pin is composed of a conductive material.

14. The cylindrical secondary battery of claim 13, further comprising:
a positive electrode terminal which is inserted into the through-hole and is electrically connected to the core pin; and
a terminal gasket configured so that the positive electrode terminal and the bottom part are insulated from and sealed with respect to each other.

15. The cylindrical secondary battery of claim 14, wherein the core pin has a plurality of through-holes in an outer circumferential surface thereof that are arranged with each in a circumferential direction of the core pin.

16. The cylindrical secondary battery of claim 7, wherein the core pin is composed of an insulating material.

17. The cylindrical secondary battery of claim 1, wherein the first electrode plate is not welded to the collecting plate, and the second electrode plate is not welded to the bottom part when the cylindrical secondary battery is in operation.

18. The cylindrical secondary battery of claim 1, wherein the first electrode plate is operably and electrically connected and not welded to the collecting plate, and wherein the second electrode plate is operably and electrically connected and not welded to the bottom part.
